(19) United States
(12) Patent Application Publication
(10) Pub. No.: US 2025/0061743 A1
(43) Pub. Date: Feb. 20, 2025

(54) AUTHENTICATION SYSTEM, INFORMATION PROCESSING APPARATUS, INFORMATION PROCESSING METHOD, AND RECORDING MEDIUM

(71) Applicant: CANON KABUSHIKI KAISHA, Tokyo (JP)

(72) Inventor: YASUO BAMBA, Tokyo (JP)

(21) Appl. No.: 18/796,104

(22) Filed: Aug. 6, 2024

(30) Foreign Application Priority Data
Aug. 14, 2023 (JP) 2023-132060

(51) Int. Cl. G06V 40/16; G06F 21/32; G06V 10/94; G06V 10/98; G06V 40/40; G06V 40/50; G06V 40/60

(52) U.S. Cl. CPC G06V 40/172; G06F 21/32; G06V 10/945; G06V 10/993; G06V 40/171; G06V 40/45; G06V 40/174; G06V 40/50; G06V 40/67

(57) ABSTRACT

An information processing apparatus includes one or more memories storing instructions, and one or more processors that, upon execution of the stored instructions, are configured to identify a person based on a face feature amount extracted from one or more face images including a face of the person, recognize, based on the face feature amount, a specific state of the face as a face input performed by the identified person from the one or more face images including the face of the identified person, and execute processing of selecting one of a plurality of selection items based on the recognized face input.

### BACKGROUND

### Field

The present disclosure relates to an authentication system, an information processing apparatus, an information processing method, and a recording medium.

### Description of the Related Art

In recent years, many techniques of extracting useful information by sophisticatedly processing images have been proposed. Among these techniques, research and development works have been actively performed especially on face authentication that determines who appears in an input face image, by comparing an input face image and pre-registered face images of a plurality of persons using a multilayer neural network called a deep network. The deep network is also referred to as a deep neural network or deep learning.

Furthermore, along with the accuracy improvement of face recognition, the development work also has been performed on a handsfree payment system and a handsfree automatic ticket gate system that use a face authentication technique. In these systems, so-called one-to-N authentication is performed. The one-to-N authentication compares facial feature information (facial feature amounts) specific to a person to be authenticated obtained from a facial image of the person with facial feature amounts pre-registered in a system to identify who the person to be authenticated is. The one-to-N authentication enables the person to be authenticated to make payment or pass through an automatic ticket gate only with his or her face without using an accessory, such as an identification (ID) card.

In using a system that utilizes face authentication, convenience can be improved by enabling a person to be authenticated to make selection of some sort in addition to person identification that uses face authentication. One example of the selection is a payment method. When making a payment, it may be convenient if the person to be authenticated can select a payment method provided by a credit company A in a certain case or a payment method provided by a credit company B in another case.

Another example of the selection is an account. For example, when checking into a hotel, it may be convenient if the person to be authenticated can make a check-in as an individual member in a certain case or as a corporate member in another case. As yet another example of the selection is a service. It may be convenient if the person to be authenticated can select a desired service together with identification by facial authentication.

The face authentication uses biological information (face) unique to each person. For this reason, a system requires special consideration to enable a person to be authenticated to make a selection of some sort at the same time.

An information processing apparatus discussed in Japanese Patent Application Laid-Open No. 2011-108148 uniquely identifies a person to be authenticated by face authentication, and then displays a list of accounts associated with the person to be authenticated, on a display unit. The information processing apparatus then allows the person to be authenticated to select an account to be used by the person to be authenticated, using an input device such as a mouse or a keyboard.

In addition, an information processing apparatus discussed in Deng, Jiankang, et al. “Arcface: Additive angular margin loss for deep face recognition.”, Proceedings of the Institute of Electrical and Electronics Engineers (IEEE) Conference on Computer Vision and Pattern Recognition. 2019. (hereinafter, Deng et al.) uses an input device such as a mouse or a keyboard to allow a person to be authenticated to select an account.

The information processing apparatus discussed in the above-described literature uses an input device such as a mouse or a keyboard to allow a person to be authenticated to select an account, and therefore many works are required to select an account. A concern with the above discussed methods is that it takes time for a person to be authenticated.

### SUMMARY

The present disclosure is directed to efficiently specifying a person representing a person to be authenticated and selecting a selection item.

According to an aspect of the present invention, an information processing apparatus includes one or more memories storing instructions, and one or more processors that, upon execution of the stored instructions, are configured to identify a person based on a face feature amount extracted from one or more face images including a face of the person, recognize, based on the face feature amount, a specific state of the face as a face input performed by the identified person, from the one or more face images including the face of the identified person, and execute processing of selecting one of a plurality of selection items based on the recognized face input.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an authentication system according to a first exemplary embodiment.

FIG. 2 is a diagram illustrating an example of a hardware configuration of an authentication apparatus according to the first exemplary embodiment.

FIG. 3 is a diagram illustrating an example of a functional configuration of the authentication system according to the first exemplary embodiment.

FIG. 4 is a flowchart illustrating a flow of a registration processing to be executed by the authentication system according to the first exemplary embodiment.

FIGS. 5A to 5E are diagrams each illustrating an example of a screen to be displayed on a registration apparatus.

FIGS. 6A to 6E are diagrams each illustrating an example of membership information to be stored in the registration processing.

FIG. 7 is a flowchart illustrating a flow of authentication processing to be executed by the authentication system according to the first exemplary embodiment.

FIG. 8 is a diagram illustrating an example of a functional configuration of an authentication system according to a second exemplary embodiment.

FIG. 9 is a flowchart illustrating a flow of authentication processing to be executed by the authentication system according to the second exemplary embodiment.

FIGS. 10A and 10B are diagrams each illustrating an example of a screen to be displayed on an authentication apparatus according to the second exemplary embodiment.

FIG. 11 is a flowchart illustrating a flow of registration processing to be executed by an authentication system according to a third exemplary embodiment.

FIG. 12 is a flowchart illustrating a flow of authentication processing to be executed by the authentication system according to the third exemplary embodiment.

FIGS. 13A to 13C are diagrams each illustrating an example of a selection table.

FIGS. 14A and 14B are diagrams each illustrating an example of a screen to be displayed on an authentication apparatus according to a fourth exemplary embodiment.

FIG. 15 is a flowchart illustrating a flow of authentication processing to be executed by an authentication system according to the fourth exemplary embodiment.

### DESCRIPTION OF THE EMBODIMENTS

Hereinafter, exemplary embodiments will be described in detail with reference to the drawings. The configurations to be described in the following exemplary embodiments are merely examples, and the configurations are not limited to the configurations illustrated in the drawings.

In a first exemplary embodiment, a description will be given of a method of allowing a person to be authenticated to select a payment method of a fare simultaneously with the person identification of the person to be authenticated when the person to be authenticated passes through an automatic ticket gate using face authentication.

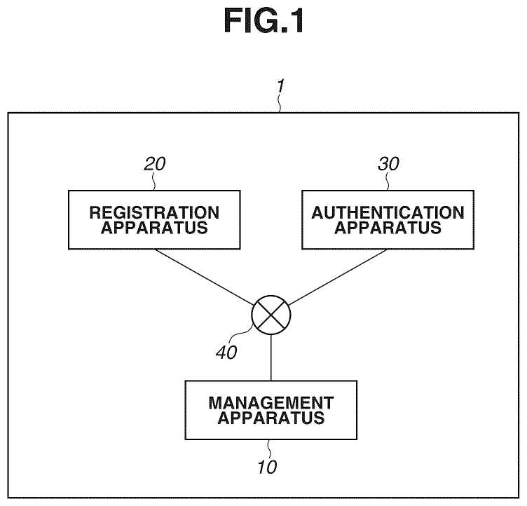

FIG. 1 is a diagram illustrating an example of a configuration of an authentication system 1 according to the first exemplary embodiment. The authentication system 1 includes a management apparatus 10, a registration apparatus 20, and an authentication apparatus 30.

The management apparatus 10 is an example of an information processing apparatus and is an apparatus for storing and managing membership information of a person to be authenticated that uses the authentication system 1. The membership information includes, for example, a face image or a face feature amount, a member ID, and an account information of a person to be authenticated. A single management apparatus 10 is disposed in a cloud, a data center, or the like.

The registration apparatus 20 is an apparatus for a person to be authenticated performing registration processing to use the authentication system 1. The registration apparatus 20 is a smartphone carried by a person to be authenticated or a terminal installed at a station, for example.

The authentication apparatus 30 is an apparatus for performing authentication processing for a person to be authenticated to get a service using the authentication system 1. The service used in the present exemplary embodiment refers to passing a ticket gate.

The authentication apparatus 30 is a terminal provided for each entrance side or an exit side of an automatic ticket gate, for example.

The management apparatus 10, the registration apparatus 20, and the authentication apparatus 30 are connected to each other by a network 40. Data transmitted and received by these apparatuses via the network 40 is encrypted using a known encryption method and prevented from being altered or tapped. While one registration apparatus 20 and one authentication apparatus 30 exist in the configuration example in FIG. 1, a plurality of registration apparatuses 20 or a plurality of authentication apparatuses 30 may exist. The management apparatus 10 may also be divided into a plurality of management apparatuses and arranged in a dispersed manner.

The management apparatus 10, the registration apparatus 20, and the authentication apparatus 30 need not be independent apparatuses and may be integrally formed apparatuses. For example, one apparatus may serve as the registration apparatus 20 and the authentication apparatus 30. One apparatus may also serve as the management apparatus 10 and the registration apparatus 20.

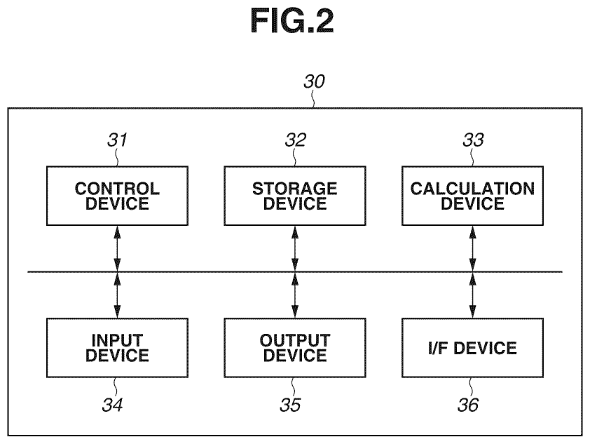

FIG. 2 is a diagram illustrating a hardware configuration example of the authentication apparatus 30 in FIG. 1. The authentication apparatus 30 includes, as a hardware configuration, a control device 31, a storage device 32, a calculation device 33, an input device 34, an output device 35, and an interface (I/F) device 36. The management apparatus 10 and the registration apparatus 20 also have the configuration equivalent to that of the authentication apparatus 30, and thus the description will be omitted.

The control device 31 controls the entire authentication apparatus 30. The storage device 32 stores programs and data to be used for an operation of the control device 31. The calculation device 33 executes necessary calculation processing based on control from the control device 31.

The input device 34 serving as a human interface device or the like inputs operations of a person to be authenticated to the authentication apparatus 30. The output device 35 is a display or the like and presents a processing result of the authentication apparatus 30 to the person to be authenticated. In place of the input device 34 and the output device 35, one device like a touch display may be provided to serve as the input device 34 and the output device 35.

The I/F device 36 is a wired interface, such as a universal serial bus, the Ethernet, and an optical cable, or a wireless interface, such as Wireless Fidelity (Wi-Fi) or Bluetooth®. The I/F device 36 has functions of inputting captured images from a connected camera to the authentication apparatus 30, transmitting, to the outside, a processing result obtained by the authentication apparatus 30, and inputting programs and data to be used for operations of the authentication apparatus 30 to the authentication apparatus 30.

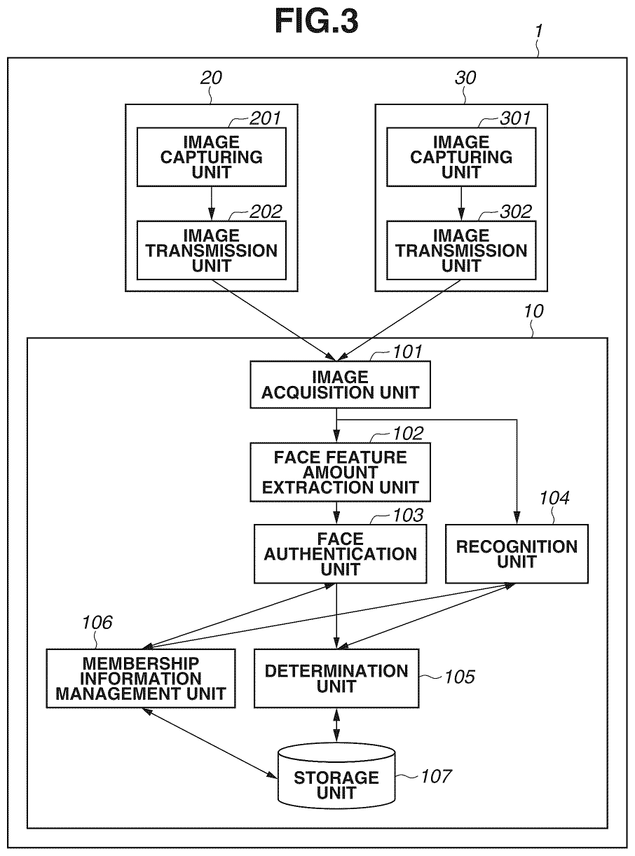

FIG. 3 is a diagram illustrating a functional configuration example of the authentication system 1 in FIG. 1. The authentication system 1 includes the management apparatus 10, the registration apparatus 20, and the authentication apparatus 30. Hereinafter, functional configuration examples of the management apparatus 10, the registration apparatus 20, and the authentication apparatus 30 will be described in detail.

The functional configurations in FIG. 3 are implemented by the control device 31 in FIG. 2 reading out predetermined programs from the storage device 32 and executing the programs. The control device 31 is a central processing unit (CPU), for example. All or part of the functional configurations in FIG. 3 may be executed by a hardware processor different from the control device 31. Examples of the hardware processor different from the control device 31 include an application specific integrated circuit (ASIC), a field programmable gate array (FPGA), and a digital signal processor (DSP).

### [Management Apparatus]

The management apparatus 10 includes an image acquisition unit 101, a face feature amount extraction unit 102, a face authentication unit 103, a recognition unit 104, a determination unit 105, a membership information management unit 106, and a storage unit 107.

The image acquisition unit 101 acquires, from the registration apparatus 20 or the authentication apparatus 30, a face image sequence to be used for face authentication or face input recognition. The face image sequence refers to one or more temporally consecutive images each including a face of a person to be authenticated. The face image sequence may be configured to include a circumferential region of the face. The face input will be described below. The face image sequence acquired by the image acquisition unit 101 is transmitted to the face feature amount extraction unit 102 and the recognition unit 104.

The face feature amount extraction unit 102 acquires a face feature amount to be used in face authentication from the face image sequence acquired by the image acquisition unit 101. The face feature amount acquired by the face feature amount extraction unit 102 is transmitted to the face authentication unit 103.

The face authentication unit 103 compares the face feature amount acquired by the face feature amount extraction unit 102 and face feature amounts (registered face feature amounts) corresponding to N persons that are stored in the storage unit 107, and identifies whether the person to be authenticated is any person among the N persons whose face feature amounts are stored in the storage unit 107 or a person different from all of the N persons. An authentication result obtained by the face authentication unit 103 is transmitted to the determination unit 105.

The recognition unit 104 recognizes a face input performed by the person to be authenticated, using the face image sequence of the person to be authenticated that has been acquired by the image acquisition unit 101. The recognized face input is transmitted to the determination unit 105.

In here, the “face input” is referred to as a coined term meaning both of bringing a face, a body part other than a face, a specific object, and an accessory into a specific state, or varying these in accordance with a predetermined method, in order to cause a person to be authenticated to select one item from among a plurality of selection items. The specific format for the face input is not limited as long as the face input has a format mechanically recognizable by the recognition unit 104 to be described below. Nevertheless, it is desirable that the face input recognition is performed using a face of the person to be authenticated and its circumferential region in such a manner that face authentication and face input recognition can be performed based on an image sequence captured by the same imaging apparatus. This configuration can bring economic advantages such as an advantage that the number of imaging apparatuses can be reduced to one, and an advantage that the setting of image capturing parameters (e.g., field angle, shutter speed) of the imaging apparatus can be performed at once.

The recognition unit 104 may recognize the face input from one image among the face image sequence acquired by the image acquisition unit 101 or may recognize the face input from a plurality of time-series images.

For example, a case of recognizing a face input of “face oriented rightward” is assumed. At this time, the recognition unit 104 determines whether the face of the person to be authenticated is in a right-oriented state by using only one image of the face image sequence.

In addition, a case of recognizing a face input of “facing to the right” is assumed. At this time, the recognition unit 104 determines whether a variation of face orientation gradually changing from a front-oriented state to a right-oriented state exists by using a plurality of time-series images among the face image sequence.

In the case of recognizing a face input from a plurality of images, as compared with the case of recognizing a face input from one image, a cost incurred in implementing face input recognition of the recognition unit 104 increases. Nevertheless, defensibility against a presentation attack (i.e., an attack of trying to break through authentication by placing paper on which an attack target face is printed, in front of a camera) by a malicious person can be improved.

Examples of face inputs recognizable by the recognition unit 104 using only one image are listed in (1) to (7) below. These face inputs are examples and are not intended to limit the type of face input.

### (1) State of Face Part

The recognition unit 104 can acquire position information of a face part by preliminarily training a part point position detector that detects the position of an end point of a face part such as an eye, a nose, a mouth, or an eyebrow. For example, the recognition unit 104 can recognize a face input such as “raised right eyebrow” or “raised left eyebrow”.

By preliminarily training a classifier that determines an open/close state of a face part such as an eye or a mouth, the recognition unit 104 can identify an open/close state of an eye or a mouth. For example, the recognition unit 104 can recognize a face input such as “opened mouth”, “closed right eye”, or “closed left eye”.

The recognition unit 104 can also train a classifier in such a manner as to determine a state more complicated than a simple opened/closed state. For example, the recognition unit 104 can recognize a face input, such as “mouth for pronouncing “A”” or “mouth for pronouncing “I”” by preliminarily training an estimator that estimates a character from a shape of the mouth.

These face inputs can also be recognized by method of using position information of a face part that is obtained from the above-described part point position detector. For example, if the part point position detector is configured to be able to output position information, such as a right end, a left end, an upper end, or a lower end of a right eye, the recognition unit 104 can recognize the state (opened state or closed state) of the right eye using a part point position as a hint.

### (2) State of Face Orientation

By preliminarily training a face orientation estimator that estimates a yaw angle, a pitch angle, and a roll angle of face orientation, the recognition unit 104 can identify the face orientation. For example, the recognition unit 104 can recognize a face input, such as “right-oriented face”, “left-oriented face”, “up-oriented face”, “down-oriented face”, “face tilted rightward”, or “face tilted leftward”.

### (3) State of Face Expression

By preliminarily training an expression classifier that identifies an expression, the recognition unit 104 can identify an expression. For example, the recognition unit 104 can recognize a face input, such as “smile”, “angry”, “surprised”, or “sad”.

### (4) State of Eye Direction

By preliminarily training an eye direction detector that detects an eye direction, the recognition unit 104 can acquire an eye direction. For example, the recognition unit 104 can recognize a face input, such as “rightward visual line”.

(5) State of Body Part Other than Face

For example, a case of using a hand as a region to be identified will be assumed. By preliminarily training a finger detector that detects joint positions of fingers, the recognition unit 104 can detect the positions and the states of the fingers. For example, the recognition unit 104 can recognize a face input, such as “right hand with n fingers held up (n is an integer from 1 to 5) that is arranged beside a right ear”, or “right hand placed over a right eye”.

### (6) State of Specific Object

By preliminarily training a detector of a specific object (e.g., an employee ID card, a badge, or a cap that is owned only by employees of a certain company), the recognition unit 104 can acquire the position of a specific object. For example, the recognition unit 104 can recognize a face input, such as “employee ID card positioned beside a right ear”.

Similarly, the recognition unit 104 can acquire the state of a specific object by preliminarily training a classifier of the state of a specific object. For example, the recognition unit 104 can recognize a face input, such as “badge with its obverse side oriented forward” or “badge with its reverse side oriented forward”.

### (7) State of Accessory

By preliminarily learning a detector of an accessory (sunglasses, mask, etc.), the recognition unit 104 can acquire the presence or absence of an accessory. For example, the recognition unit 104 can recognize a face input such as “with sunglasses”.

Examples have been listed above of face inputs that are based on states of a face, a body part other than a face, a specific object, or an accessory. A time-series variation of a face, a body part other than a face, a specific object, or an accessory changing in order like a state s1, a state s2, . . . , a state sK (K is an integer of two or more) can also be defined as a face input. In other words, the following variations (8) to (14) are all recognizable face inputs.

### (8) Variation of Face Part

### (9) Variation of Face Orientation

### (10) Variation of Face Expression

### (11) Variation of Eye Direction

(12) Variation of Body Part Other than Face

### (13) Variation of Specific Object

### (14) Variation of Accessory

A face input including such a time-series change is assumed to be recognized using a plurality of time-series face images. By applying the above-described detector or classifier to each of a plurality of time-series face images, and using a result of the application, the recognition unit 104 becomes able to recognize a face input including a time-series change.

Examples of face inputs recognizable by the recognition unit 104 using a plurality of time-series face images will be listed below. These face inputs are examples and are not intended to limit the type of face input.

Examples of “variation of a face part” include face inputs, such as “raise a right eyebrow”, “raise a left eyebrow”, “open a mouth”, “close a right eye”, “close a left eye”, and “make a silent gesture with one's mouth like pronouncing a character string XXX”. Making a silent gesture with one's mouth means the movement of the mouth when the character string is pronounced. By preliminarily training an estimator that estimates a character string from the movement of the mouth, the recognition unit 104 can recognize the face input.

Examples of “variation of a face orientation” include face inputs, such as “face to the right”, “face to the left”, “look up”, “look down”, “tilt a face rightward”, “tilt a face leftward”, or “shake one's head”.

Examples of “variation of a face expression” include face inputs, such as “change an expression from straight face to smile”.

Examples of “variation of an eye direction” include face inputs, such as “move a visual line from right to left”.

Examples of “variation of body part other than a face” include face inputs, such as “shake a right hand from right to left”, “draw a circle in midair with a finger”, and “run fingers through hair with a right hand”.

Examples of “variation of a specific object” include face inputs, such as “turn a badge from the obverse side to the reverse side”.

Examples of “variation of an accessory” include face inputs, such as “wear sunglasses”.

The above-described face input recognition methods are examples, and any known method can be applied to face input recognition.

The determination unit 105 determines an item selected by a person to be authenticated, based on an authentication result of a person obtained by the face authentication unit 103, a face input recognized by the recognition unit 104, and membership information stored in the storage unit 107.

The membership information management unit 106 acquires membership information of the person to be authenticated and stores the membership information into the storage unit 107 in cooperation with the registration apparatus 20. The membership information corresponds to a general account table or an account table to be described below, for example. The details will be described below.

The storage unit 107 stores membership information of the person to be authenticated. The membership information is stored in a machine-readable format such as a database or texts.

[Registration Apparatus]

Next, a functional configuration example of the registration apparatus 20 will be described in detail. The registration apparatus 20 includes an image capturing unit 201 and an image transmission unit 202.

The image capturing unit 201 controls an imaging apparatus to capture images to be used for face authentication or face input recognition. The images captured by the image capturing unit 201 are transmitted to the image transmission unit 202. The image transmission unit 202 transmits the images captured by the image capturing unit 201 to the management apparatus 10.

[Authentication Apparatus]

Lastly, a functional configuration example of the authentication apparatus 30 will be described in detail. The authentication apparatus 30 includes an image capturing unit 301 and an image transmission unit 302.

The image capturing unit 301 controls an imaging apparatus to capture images to be used for face authentication or face input recognition. The images captured by the image capturing unit 301 are transmitted to the image transmission unit 302. The image transmission unit 302 transmits the images captured by the image capturing unit 301 to the management apparatus 10.

Heretofore, the functional configuration example of the authentication system 1 has been described. The above-described functional configuration example is an example, and the functional configuration is not limited to this. For example, a configuration may be employed in which the authentication apparatus 30 has the function of the face feature amount extraction unit 102 included in the management apparatus 10, and not a face image but a face feature amount is transmitted from the authentication apparatus 30 to the management apparatus 10.

The authentication system 1 according to the present exemplary embodiment performs registration processing and authentication processing. Hereinafter, a flow of the registration processing and a flow of the authentication processing will be described in order.

### [Registration Processing]

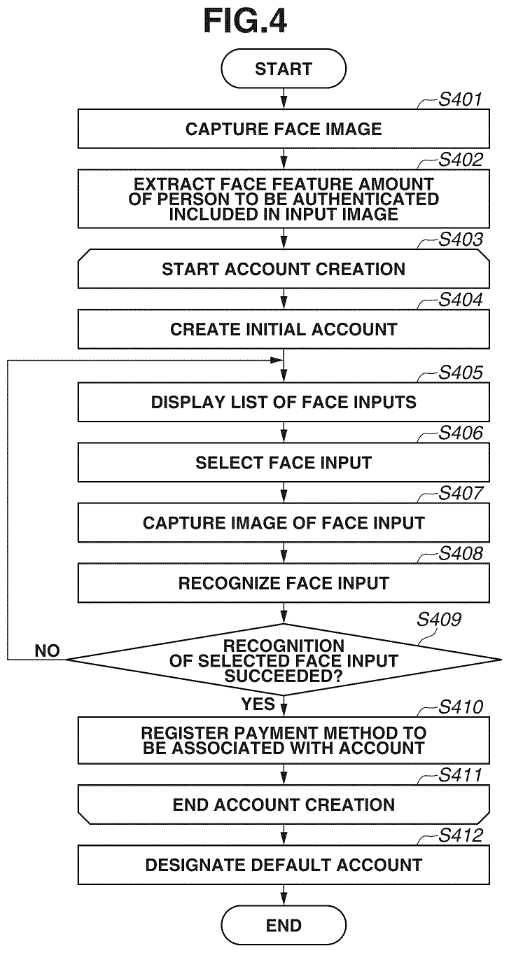

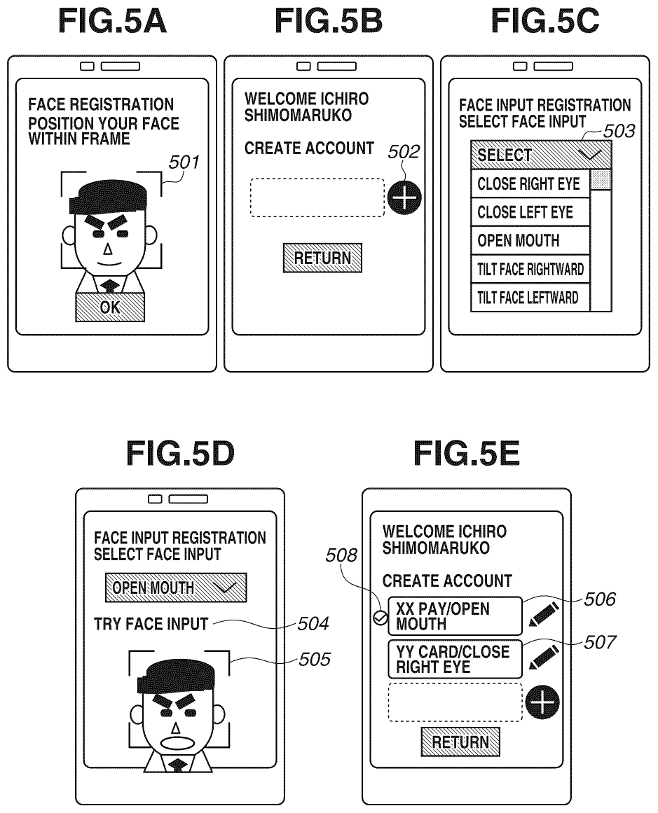

FIG. 4 is a flowchart illustrating a flow of the registration processing to be executed by the authentication system 1. FIGS. 5A to 5E are diagrams each illustrating an example of a screen to be displayed on a touch display (serving as an input device and an output device) included in the registration apparatus 20. An example of a registration processing method to be employed by the management apparatus 10 and the registration apparatus 20 will be described with reference to FIGS. 4 and 5A to 5E.

Here, the registration apparatus 20 is assumed to be a smartphone held by a person to be authenticated, but may be another terminal, such as a terminal installed at a station. The person to be authenticated first creates their general account through an operation of an application preinstalled in the registration apparatus 20, using a conventional method that uses an e-mail address and a password, and performs the following processing in a state of having logged into the general account.

When the general account is created, a unique ID for identifying a person to be authenticated is newly issued by the membership information management unit 106. This ID will be hereinafter referred to as a person ID. FIGS. 5A to 5E are examples of a screen to be displayed on the touch display included in the registration apparatus 20. The person to be authenticated operates the touch display of the registration apparatus 20 and performs the registration processing, and thereby the registration apparatus 20 and the management apparatus 10 appropriately cooperate with each other, and the membership information of the person to be authenticated is stored into the storage unit 107 of the management apparatus 10.

In step S401, the image capturing unit 201 captures a face image sequence to be used for face authentication. When the face image sequence is captured, as illustrated in FIG. 5A, the registration apparatus 20 may display a guide 501 and issue an instruction to the person to be authenticated in such a manner that a face appears in a size suitable for face recognition. The face image sequence may be one image.

The image transmission unit 202 transmits the face image sequence captured by the image capturing unit 201 to the image acquisition unit 101 of the management apparatus 10.

In step S402, the image acquisition unit 101 acquires the face image sequence transmitted by the image transmission unit 202. The face feature amount extraction unit 102 extracts (acquires) a face feature amount to be used for face authentication, based on the face image sequence of the person to be that has been acquired by the image acquisition unit 101.

A preliminarily learned feature extractor is used for the extraction of a face feature amount. In the face feature amount extraction unit 102, if a face image having been subjected to predetermined normalization processing is input to the feature extractor, biological information (face feature amount) called a feature amount for identifying the identity of a face is output from the feature extractor. In general, the face feature amount is often a feature vector in a fixed dimension (e.g., 256 or 512 dimensions). The feature extractor is preliminarily trained in such a manner that face feature amounts extracted from face images of the same person have a high similarity degree, and face feature amounts extracted from face images of different persons have a low similarity degree. The feature extractor can be trained using a known method discussed in Deng et al., for example.

The face feature amount registration processing in steps S401 and S402 is typically required to be performed only once for each account. Nevertheless, external appearances of faces vary across the ages, and thus date and time on which a face feature amount has been registered may be recorded, and in a case where a predetermined number of years (e.g., five years) have passed from the date and time on which has been registered, the person to be authenticated may be prompted to register a face feature amount again.

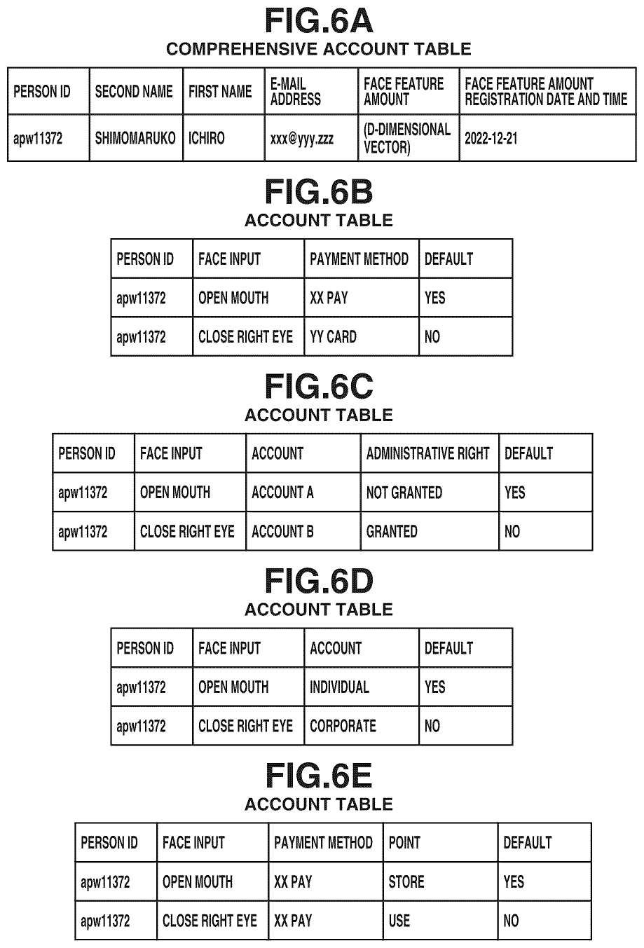

The membership information management unit 106 associates the extracted face feature amount with a person ID, and stores (registers) the face feature amount into the storage unit 107 as membership information. As an example, the membership information is stored as the general account table illustrated in FIG. 6A. The general account table is a table storing data related to a general account. In the general account table, personal information, such as a name or an e-mail address, and a face feature amount are stored in association with the person ID. In addition to the face feature amount, a face image may be additionally stored in the general account table. By additionally storing the face image, a face feature amount can be regenerated from the face image when the face feature amount extractor is updated in a future.

The processing in steps S403 to S411 corresponds to a loop of account creation processing. For example, in a case where a person to be authenticated registers two types of fare payment methods, the authentication system 1 repeats this loop twice.

In step S404, the membership information management unit 106 prompts the person to be authenticated to perform account creation. FIG. 5B illustrates a display example of the touch display included in the registration apparatus 20. For example, the membership information management unit 106 creates an initial account by the person to be authenticated pressing an account addition button 502.

In step S405, the membership information management unit 106 presents a list of face inputs settable by the person to be authenticated, to the person to be authenticated in the form of a list or the like. FIG. 5C illustrates a display example of the touch display included in the registration apparatus 20. For example, if the person to be authenticated selects a pulldown menu 503, choices of face inputs selectable by the person to be authenticated are displayed as a list.

The face inputs selectable by the person to be authenticated may be made controllable by an administrator in accordance with a scene where the authentication apparatus 30 is used. For example, in a scene where the number of authentications per unit time needs to be made large like a ticket gate at a station, only face inputs that can execute face inputs and recognition at high speed can be included. In a scene where large payment might be made, face inputs that can also be used for spoofing determination (to be described in detail in a second exemplary embodiment) can be included to reduce a risk of mix-up with a different person.

In step S406, the person to be authenticated selects one face input from among the presented face inputs. This can be implemented by the person to be authenticated selecting one face input from the pulldown menu 503 in FIG. 5C, for example.

In step S407, the image capturing unit 201 captures an image for the face input selected in step S406 and performed by the person to be authenticated. The image capturing is performed in the following procedure, for example. First, the person to be authenticated selects a face input in step S406, and then the membership information management unit 106 presents a screen of the registration apparatus 20 as illustrated in FIG. 5D to the person to be authenticated. On this screen, a message 504 that prompts the person to be authenticated to execute a face input and a guide 505 into which a face is to be fitted are displayed, and the person to be authenticated is prompted to capture an image for the face input. Next, the membership information management unit 106 issues a request to the image capturing unit 201 of the registration apparatus 20, and the image capturing unit 201 captures a face image sequence of the face input performed by the person to be authenticated. The captured face image sequence is transmitted to the image transmission unit 202. The image transmission unit 202 transmits the received face image sequence to the image acquisition unit 101 of the management apparatus 10.

In step S408, the image acquisition unit 101 acquires the face image sequence transmitted by the image transmission unit 202. The recognition unit 104 recognizes the face input performed by the person to be authenticated, from the face image sequence acquired by the image acquisition unit 101. The execution example of face input recognition is as described above.

In step S409, the membership information management unit 106 determines whether the face input recognized in step S408, and the face input selected by the person to be authenticated in step S406 are identical. In a case where the face inputs are identical (YES in step S409), the processing proceeds to step S410. In a case where the face inputs are not identical (NO in step S409), the processing returns to step S405, and the processing is redone from the display of a list of face inputs. By performing the processing, it is possible to prevent the person to be authenticated from erroneously employing an inexecutable face input.

In step S410, the membership information management unit 106 prompts the person to be authenticated to register a payment method to be associate with an account. The person to be authenticated inputs information (e.g., ID, password) to be used for payment to a certain credit company, for example, and issues an instruction to associate the information with this account.

The membership information management unit 106 subsequently associates the face input selected in step S406 and the payment information registered in step S410 with the initial account created in step S404, and stores the information into the storage unit 107 as an account table. A specific example will be described below.

In step S412, the membership information management unit 106 prompts the person to be authenticated to set one account among the created accounts as a default account. The default account is an account to be automatically selected in a case where face input recognition has failed in the authentication processing to be described below. It is not always necessary to cause the person to be authenticated to explicitly select a default account. An account created first may be set as a default account.

FIG. 5E illustrates an example of a screen of the registration apparatus 20 that is presented to the person to be authenticated after the loop of the account creation processing in steps S403 to S411 is cycled twice. In FIG. 5E, two pieces of account information are respectively displayed in a box 506 and a box 507, and the person to be authenticated can check payment information and a face input associated with each account. A checkmark 508 is a symbol indicating that the ticked account is a default account.

As an example, the membership information obtained after the loop of the account creation processing in steps S403 to S411 is cycled twice is indicated as an account table illustrated in FIG. 6B.

The account table is a table storing membership information regarding an account created by the person to be authenticated. In this example, two records exist in the account table in accordance with two accounts created by the person to be authenticated. Each account is associated with information regarding a face input, a payment method, and information indicating whether a corresponding account is a default account. Only one default account exists for each person to be authenticated.

As described above, in step S410, the membership information management unit 106 functions as a registration unit and registers an account table of a plurality of associations of face inputs and payment methods for each person ID as illustrated in FIG. 6B. Specifically, the membership information management unit 106 controls options of face inputs illustrated in FIG. 5C to be displayed in step S405, and registers the account table in FIG. 6B that associates a face input selected from the face input options and a payment method.

Heretofore, an example has been described of a flow of the registration processing executed by the registration apparatus 20 according to the present exemplary embodiment. The flow of the registration processing is not limited to this, and various modifications can be made.

For example, modification can be made in such a manner as to associate a plurality of types of face inputs with one account. For example, a plurality of types of face inputs, such as “wave a right hand” and “close a right eye”, are associated with one account. This modification makes it possible for the person to be authenticated to normally execute a face input by waving a right hand, and in a case where the person to be authenticated has no free hand due to baggage, to execute a face input of closing a right eye, and thereby the convenience of the person to be authenticated improves.

In a case where face inputs associated with a plurality of accounts are similar to each other during the authentication processing, an account unintended by the person to be authenticated might be selected due to a failure in face input recognition.

For this reason, a method can be devised as a conceivable modification. The modification allows the type of a face input to be associated with an account to be determined in such a manner that all face inputs associated with the account are dissimilar to each other (i.e., face inputs can easily be discriminated by a machine).

An example of the method of implementing the modification will be described below. Hereinafter, it is assumed that numbers a1 to an are allocated to n pieces of face inputs settable by the person to be authenticated. It is assumed that the person to be authenticated has associated (k−1) pieces of face inputs b1, . . . , and b(k−1) with any account.

First, a function f (ai, aj) is predefined. The function defines a similarity degree between ai (i-th face input) and aj (j-th face input). Any determination may be used as a determination method of the similarity degree. For example, the similarity degree may be determined by a person based on a rule. Alternatively, a similarity degree may be statistically determined in such a manner that a similarity degree of a set of face inputs that are likely to be mixed up in the face input recognition executed by the recognition unit 104 becomes high. Hereinafter, the function f (ai, aj) is assumed to return a real number larger than or equal to 0 and smaller than or equal to 1.

In step S406, it is assumed that the person to be authenticated is to select a face input “a” as a k-th face input. In step S406, the membership information management unit 106 can allow the person to be authenticated to select the face input “a” only in a case where all the face inputs b1, . . . , and b (k−1) already selected by the person to be authenticated are dissimilar to the face input “a”. The determination can be performed by obtaining a score max (f(a, b1), f(a, b2), . . . , f(a, b (k−1))) for the face input “a”, for example. In a case where this score falls below a first threshold value, it can be determined that “the face input “a” is dissimilar to all of the face inputs b1, . . . , and b(k−1) already selected by the person to be authenticated.

In step S405, the membership information management unit 106 may only present to the person to be authenticated, a face input dissimilar to all of the face inputs b1, . . . , and b(k−1) already selected by the person to be authenticated. The membership information management unit 106 controls partial options of face inputs that can be easily discriminated from each other by a machine among a plurality of face inputs to be displayed. This enables the person to be authenticated to easily select a face input only from among face inputs settable by the person to be authenticated.

The membership information management unit 106 can also recommend a face input selected by the authentication system 1 to the person to be authenticated. For example, the membership information management unit 106 defines a function g (a) for calculating a recommendation score, for the face input “a” unselected by the person to be authenticated. The membership information management unit 106 then calculates recommendation scores for all face inputs an unselected by the person to be authenticated, and presents, to the person to be authenticated, a face input list including face inputs sorted in descending order of recommendation score.

The recommendation score can be calculated by an arbitrary method. For example, a function h (a) to convert the easiness of the operation of the face input “a” into a number is predefined. The function h (a) can be determined on whichever of a rule basis and a machine learning basis. The recommendation score g (a) for the face input “a” unselected by the person to be authenticated is defined as in the following formula.

g(a)=(1−max(f(a,b1),f(a,b2), . . . ,f(a,b(k−1))))*h(a)

This method makes it easier to set a face input that can be easily operated by the person to be authenticated and involves less failures in face input recognition executed by the authentication system 1.

### [Authentication Processing]

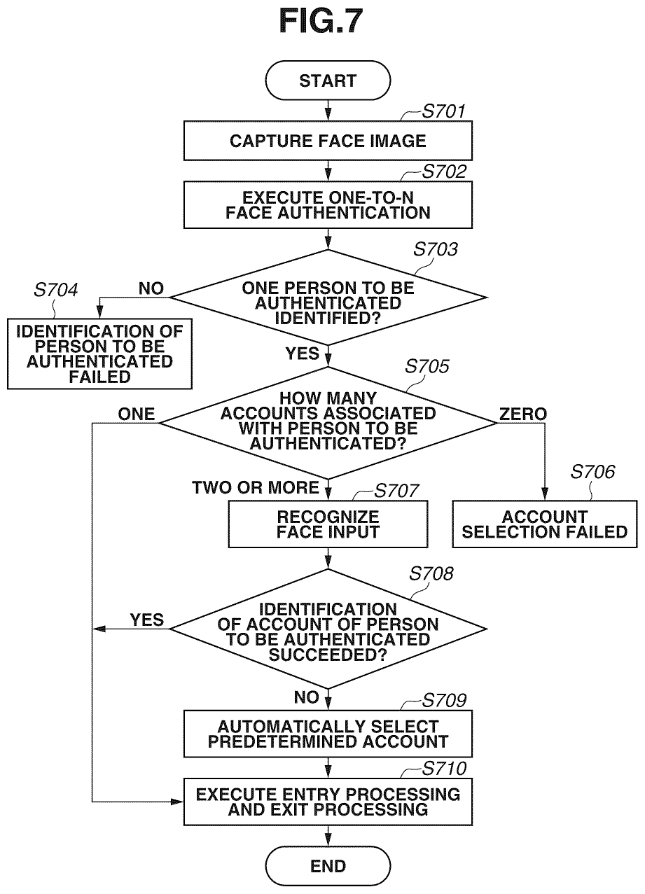

FIG. 7 is a flowchart illustrating a flow of the authentication processing to be executed by the authentication system 1. An example of an authentication processing method employed by the management apparatus 10 and the authentication apparatus 30 according to the present exemplary embodiment will be described with reference to FIG. 7.

Here, it is assumed that the authentication apparatus 30 is a terminal provided for each entrance side or an exit side of an automatic ticket gate. An imaging apparatus connected to the authentication apparatus 30 is installed at the height of 1.6 m from the floor, for example, and installed at an angle at which a face of a person passing through the automatic ticket gate is unlikely to be shielded.

An image capturing range being a range in which an image of the face of the person to be authenticated can be captured under a desirable condition is preset in the authentication apparatus 30. The image capturing range is set as a range from 2 m (meters) to 1 m in front of the automatic ticket gate, for example.

When the person to be authenticated walks toward the automatic ticket gate, the person to be authenticated gives an eye to the imaging apparatus while the person to be authenticated stays in the image capturing range and performs a face input for account selection at an arbitrary timing in the period in which the person to be authenticated stays in the image capturing range.

The authentication system 1 performs face authentication and account selection based on a face image sequence captured in the image capturing range. It is assumed that the person to be authenticated that passes through the automatic ticket gate has preliminarily ended the above-described registration processing.

In step S701, the image capturing unit 301 captures a face image sequence to be used for face authentication and face input recognition. The face image sequence includes one or more face images each including the face of the person to be authenticated. The capturing of the face image sequence is triggered by the entry of the person to be authenticated into the image capturing range, for example. If the person to be authenticated turns toward the imaging apparatus, the accuracy of face authentication and face input recognition improves. Thus, the person to be authenticated may be prompted to perform a cooperate work, using a method of, for example, changing the color of the floor in the image capturing range, putting marks such as footstep marks on the floor in the image capturing range, or issuing a sound or light notification while the person to be authenticated is within the image capturing range.

Alternatively, a touch display (serving as the input device 34 and the output device 35) may be installed at the automatic ticket gate. By displaying a live view video captured by the imaging apparatus on the touch display and superimposing a guide frame into which the face is to be fitted onto the touch display, it is possible to capture an image of the person to be authenticated more desirably. In the case of recognizing a face input performed using an object other than the face (e.g., hand, employee ID card) in the face input recognition to be described below, the guide frame may be adjusted in such a manner as to include a circumferential region other than the face.

The image transmission unit 302 transmits the face image sequence captured by the image capturing unit 301 to the image acquisition unit 101 of the management apparatus 10.

In step S702, the image acquisition unit 101 acquires the face image sequence transmitted by the image transmission unit 302. The management apparatus 10 performs one-to-N authentication. The one-to-N authentication is implemented in the following procedure, for example.

First, the face feature amount extraction unit 102 extracts, from the face image sequence acquired by the image acquisition unit 101, a face feature amount of the person to be authenticated. This can be implemented using the method described in step S402. The same algorithm is basically used for face feature amount extraction in the registration processing and face feature amount extraction in the authentication processing.

Various methods can be employed as a method of determining an image from which a face feature amount is to be extracted. One example is a method of using a face image quality score (face image quality assessment score). The face image quality score is a value that indicates a degree to which a face image is suitable for face authentication, and can be calculated using a known method, such as FaceQNet v1.

First, the face feature amount extraction unit 102 calculates a face image quality score for each face image included in the face image sequence acquired by the image acquisition unit 101. Next, the face feature amount extraction unit 102 extracts face feature amounts from top n (n is an integer of 1 or more) face images having high face image quality scores. Lastly, the face feature amount extraction unit 102 extracts a final face feature amount by calculating a simple average or a weighted average using the face image quality scores of the extracted face feature amounts.

For example, when the person to be authenticated performs a face input of looking away or closing one eye, a face image quality score is expected to become lower, and when the person to be authenticated turns toward the imaging apparatus with a straight face, a face image quality score is expected to become high. For this reason, even if a timing at which the person to be authenticated is not performing an operation for face input is instantaneous, it is possible to execute highly accurate face authentication using an image captured at the timing.

Subsequently, the face authentication unit 103 calculates a matching score between the face feature amounts acquired by the face feature amount extraction unit 102 and face feature amounts (registered face feature amounts) corresponding N persons that are stored in the storage unit 107. The registered face feature amounts are acquired by referring to the membership information (general account table). The matching score is calculated based on, for example, a cosine similarity degree or an L2 distance between feature amounts.

In step S703, the face authentication unit 103 functions as an identification unit and identifies a person with the highest matching score among the matching scores corresponding to the N persons that have been calculated in step S702, as a person A indicating the person to be authenticated. The face authentication unit 103 then compares the matching score of the person A with a second threshold value. In a case where the matching score of the person A is smaller than the second threshold value, it is determined that the person to be authenticated is a person different from all of the N persons, and the processing proceeds to step S704. In step S704, the face authentication unit 103 determines that the identification of the person to be authenticated has failed. In this case, the management apparatus 10 prompts the person to be authenticated to pass through the automatic ticket gate using a method other than face authentication, for example, by closing the automatic ticket gate. At this time, the management apparatus 10 may display a message indicating that person identification has failed on the touch display on the authentication apparatus 30.

In a case where the matching score of the person A is larger than or equal to the second threshold value, the face authentication unit 103 determines that the person to be authenticated is identified as the person A, and the processing proceeds to step S705. At this time, the management apparatus 10 may display a person ID or a name of the person A on the touch display on the authentication apparatus 30. If an authentication result includes an error, the management apparatus 10 may cause the person to be authenticated to correct the error.

In step S705, the determination unit 105 refers to the membership information (account table in FIG. 6B) stored in the storage unit 107, and counts the number of accounts associated with the person A. If the number of accounts associated with the person A is zero (“ZERO” in step S705), the determination unit 105 advances the processing to step S706. In step S706, the determination unit 105 determines that account selection has failed. In this case, the management apparatus 10 prompts the person to be authenticated to pass through the automatic ticket gate using a method other than face authentication, for example, by closing the automatic ticket gate. At this time, the management apparatus 10 may display a message indicating that an account does not exist on the touch display of the authentication apparatus 30.

In a case where the number of accounts associated with the person A is one (“ONE” in step S705), the determination unit 105 selects the one account, and the processing proceeds to step S710. In a case where the number of accounts associated with the person A is two or more (“TWO OR MORE” in step S705), the processing proceeds to step S707.

In step S707, the recognition unit 104 recognizes a face input performed by the person to be authenticated, based on the face image sequence of the person to be authenticated that has been acquired by the image acquisition unit 101. The face input recognition can be performed using the same method as the method described in step S408.

In step S708, the determination unit 105 compares the face input recognized in step S707 with the membership information (account table in FIG. 6B) stored in the storage unit 107, and identifies an account selected by the person to be authenticated. This can be implemented by sequentially referring to records in the account table that are associated with the person A, and searching for a record in which the same face input as the face input recognized in step S707 is registered.

In a case where account identification has succeeded (YES in step S708), the determination unit 105 selects the identified account and advances the processing to step S710. At this time, the management apparatus 10 may display information regarding the identified account on the touch display of the authentication apparatus 30, and if the information includes an error, the management apparatus 10 may cause the person to be authenticated to correct the error. The correction may be performed by the person to be authenticated touching the touch display or executing a specific face input, such as head shaking toward the imaging apparatus.

In a case where account identification has failed (NO in step S708), the determination unit 105 advances the processing to step S709. This can occur in a case where the recognition of a face input performed by the person to be authenticated has failed (also including a case where the person to be authenticated has not executed any face input), or in a case where a face input executed by the person to be authenticated is associated with none of the accounts in the account table, for example.

In step S709, the determination unit 105 refers to the membership information (account table in FIG. 6B) stored in the storage unit 107, identifies one default account, and selects the identified account. Through the processing in steps S708 and S709, the person to be authenticated can employ an operation of passing through the automatic ticket gate without face input if the person to be authenticated wants to use a default payment method, or with a face input of some sort if the person to be authenticated wants to use a payment method other than the default payment method. Thereafter, the processing proceeds to step S710.

In step S710, the management apparatus 10 executes entry processing and exit processing. In the entry processing, the management apparatus 10 records information regarding a station at which the person to be authenticated has made an entry, into the storage unit 107. In the exit processing, the management apparatus 10 calculates a fare from an entry station to an exist station, selects a payment method associated with an account selected in any of steps S705, S708, and S709, and makes payment using the selected payment method.

As described above, the management apparatus 10 functions as a selection unit, selects one of a plurality of payment methods based on the face input recognized in step S707, as a selection item corresponding to the person identified in step S703, and makes payment using the selected payment method. Specifically, the management apparatus 10 selects a payment method corresponding to the face input recognized in step S707, based on the account table in FIG. 6B that has a plurality of associations of face inputs and payment methods for the person identified in step S703. The payment method is an example of the selection item, and the selection item is not limited to this. In other words, the management apparatus 10 selects one of a plurality of selection items based on the face input recognized in step S707, as a selection item corresponding to the person identified in step S703.

In step S709, in a case where a payment method corresponding to the face input recognized in step S707 does not exist in the account table in FIG. 6B, the management apparatus 10 selects a default payment method.

Heretofore, a flow of the authentication processing executed by the authentication apparatus 30 according to the first exemplary embodiment has been described. Nevertheless, the authentication processing method is not limited to the above-described method, and various modifications can be made.

For example, the method of performing one-to-N face authentication and face input recognition in order has been described with reference to the flowchart in FIG. 7. The order of the processing needs not be fixed. For example, modification can be made in such a manner that one-to-N face authentication and face input recognition are concurrently executed. This modification can further shorten a time taken for authentication processing.

The method of using the face image sequence captured in step S701, in both the one-to-N face authentication and the face input recognition has been described with reference to the flowchart in FIG. 7. The processing may be modified in such a manner as to first perform image capturing for one-to-N face authentication and perform image capturing for face input recognition immediately after the image capturing for one-to-N face authentication. At this time, for example, the management apparatus 10 may prompt the person to be authenticated to perform a cooperate work, by notifying the person to be authenticated of image capturing for one-to-N face authentication or image capturing for face input recognition as currently performed image capturing, by using light or sound on the touch display of the authentication apparatus 30. For example, while a red lamp is lit, the person to be authenticated gazes at the imaging apparatus, and if the color of the lamp changes to blue, the person to be authenticated performs a face input. Although a time taken for the entire authentication processing becomes long, a frontal face image for one-to-N face authentication can be captured reliably. Thus, the accuracy of one-to-N face authentication improves.

The method of selecting a default account in a case where face input recognition has failed has been described with reference to the flowchart in FIG. 7. In place of this method, modification can be made in such a manner as to employ a method by which the management apparatus 10 displays an account list on the touch display of the authentication apparatus 30 and causes the person to be authenticated to explicitly select one account, in a case where face input recognition has failed.

As described above, the authentication system 1 according to the first exemplary embodiment enables a person to be authenticated to select a fare payment method simultaneously with the person identification of the person to be authenticated when the person to be authenticated passes through the automatic ticket gate using face authentication. A person to be authenticated is only required to perform a face input of some sort only when the person to be authenticated wants to use a payment method other than a default payment method, and the convenience of the person to be authenticated improves.

In the above-described example, payment methods are stored in the account table in FIG. 6B, but it is possible to realize various applications by storing another type of information in the account table.

The first application is switching between a plurality of accounts in a personal computer or a smartphone. As an example, a case will be considered where two accounts corresponding to an account A of which administrative right is not granted to a certain person to be authenticated, and an account B of which administrative right is granted to the certain person to be authenticated are created. By prestoring an account table as illustrated in FIG. 6C in the storage unit 107, accounts and face inputs are associated. By performing a face input associated with a certain account, a person to be authenticated can log into the account.

In the case of the example illustrated in FIG. 6C, the person to be authenticated can log into an account without administrative right in a case where a person to be authenticated performs face authentication without performing face input. In a case where a person to be authenticated performs face authentication while performing a specific face input (here, “close a right eye”), the person to be authenticated can log into an account with administrative right. In other words, it can be construed that right of some sort is added to a person to be authenticated only in a case where the person to be authenticated additionally performs a specific face input.

This way of thinking can be applied to other cases, such as a case where a person to be authenticated uses a smartphone application of a bank. The authentication system 1 can be configured to enable a person to be authenticated to execute only an operation with low security, such as confirmation of balance, in a case where the person to be authenticated executes login only by face authentication. In contrast, the authentication system 1 can be configured to enable a person to be authenticated to execute all operations including remittance, in a case where the person to be authenticated performs face authentication while performing a specific face input.

The second application is switching of an account type. For example, a case is assumed where a certain person to be authenticated has two accounts: one is an individual account and the other is a corporate account (account created by a corporation to which the person to be authenticated belongs), and the certain person to be authenticated checks into a hotel as an individual member in some cases and as a corporate member in other cases. By prestoring an account table as illustrated in FIG. 6D in the storage unit 107, accounts and face inputs are associated. By performing a face input stored in the account table, the person to be authenticated can check into a hotel using a desired account.

The third application is switching of a service. For example, a certain payment method is assumed to have a structure of giving points in accordance with a payment amount at the time of payment. A person to be authenticated preliminarily creates an account for which points are stored at the time of payment, and an account for which points are used at the time of payment, as illustrated in an account table in FIG. 6E. By performing a face input stored in the account table, the person to be authenticated can make selection in such a manner as to save points in some cases and use points in other cases. Similarly, various types of selection can be made by storing the type of a service that a person to be authenticated desires to receive and preference of the person to be authenticated in association with an account.

The payment method in FIG. 6B is an example of the selection item. The selection items include, for example, payment method, presence or absence of administrative right, account type, service type, or preference of a person to be authenticated.

As described above, according to the present exemplary embodiment, the authentication system 1 can perform the person identification of a person to be authenticated by face authentication and the selection of a selection item by the person to be authenticated at high speed, without using a special apparatus for face authentication other than the authentication apparatus 30 and the management apparatus 10.

In a second exemplary embodiment, a description will be given of a method of enabling a person to be authenticated to select a payment method simultaneously with the person identification of the person to be authenticated when the person to be authenticated makes payment using face authentication at an electronic cash register in a supermarket or a convenience store. In the second exemplary embodiment, the description will be given of two effects of secure personal authentication and prevention of unintended authentication processing that are to be obtained by using both spoofing determination that uses a face image sequence and knowledge-based authentication that uses a face input. In the second exemplary embodiment, the description of parts similar to those in the first exemplary embodiment will be omitted, and only differences will be described.

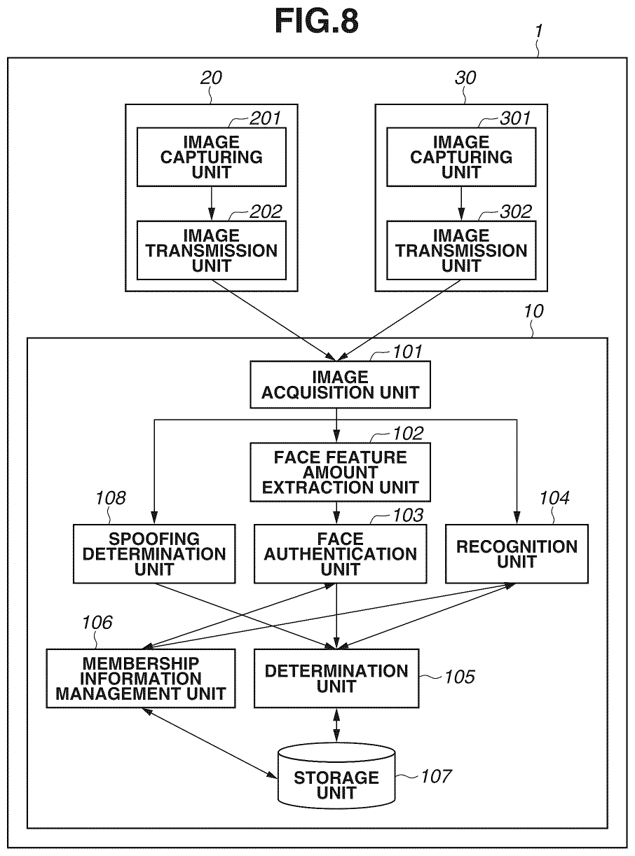

FIG. 8 is a diagram illustrating a functional configuration example of an authentication system 1 according to the second exemplary embodiment. The authentication system 1 illustrated in FIG. 8 additionally includes a spoofing determination unit 108 in addition to the components of the authentication system 1 illustrated in FIG. 3. The spoofing determination unit 108 is added to the inside of the management apparatus 10.

The spoofing determination unit 108 calculates a non-living material score, which is a score indicating a likelihood of being a non-living material, from a face image sequence acquired by the image acquisition unit 101. Based on the non-living material score, the spoofing determination unit 108 can quantify a degree of approximation of a face image to a living individual (real human) or a non-living material (person printed or displayed on an artificial material such as paper or a display).

The authentication system 1 according to the present exemplary embodiment performs registration processing and authentication processing.

### [Registration Processing]

The registration processing can be performed similarly to the method described in the first exemplary embodiment. The registration apparatus 20 is a smartphone carried by a person to be authenticated, but may be another terminal, such as a terminal installed at a store front.

### [Authentication Processing]

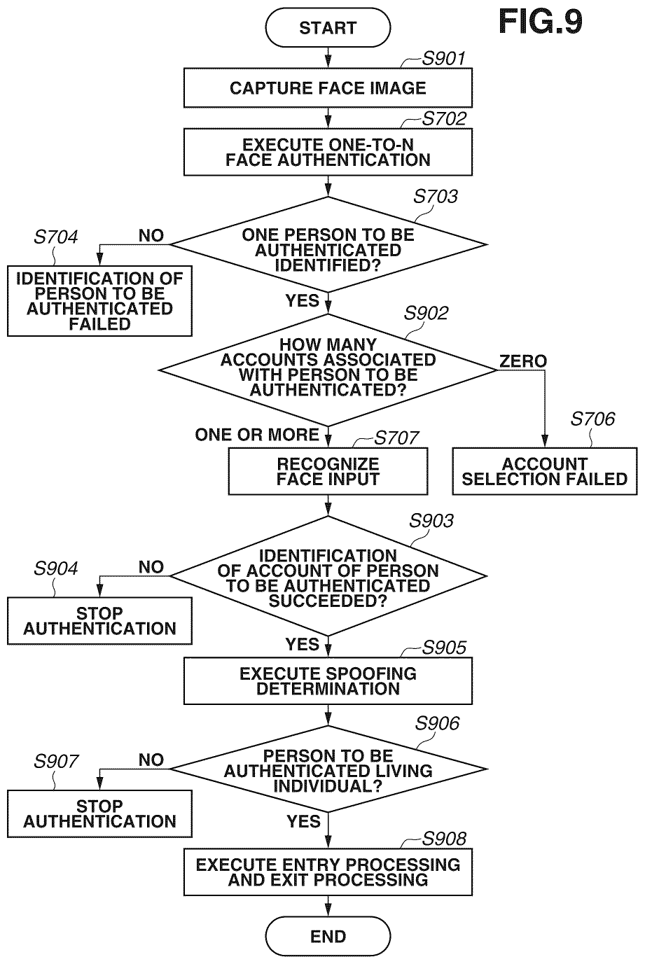

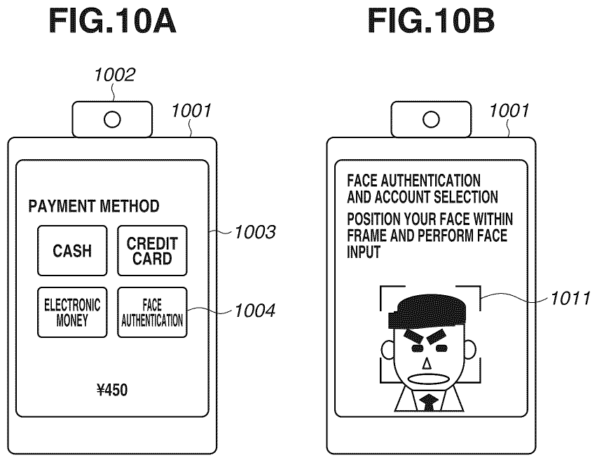

FIG. 9 is a flowchart illustrating a flow of the authentication processing to be executed by the authentication system 1 according to the second exemplary embodiment. FIGS. 10A and 10B are diagrams each illustrating an example of a screen to be displayed on the authentication apparatus 30. An example of a flow of the authentication processing to be executed by the management apparatus 10 and the authentication apparatus 30 according to the present exemplary embodiment will be described with reference to FIGS. 9 and 10A and 10B. Here, the authentication apparatus 30 is assumed to be an apparatus provided at an electronic cash register terminal in a supermarket or a convenience store, but may be another terminal such as a smartphone that is carried by a person to be authenticated.

A flow of the authentication processing will be described with reference to FIG. 9. In FIG. 9, the processing equivalent to the processing described with reference to FIG. 7 is assigned the same step number. Hereinafter, points where FIG. 9 differs from FIG. 7 will be described.

In step S901, the image capturing unit 301 captures a face image sequence to be used for face authentication, face input recognition, and spoofing determination.

An example of the capturing of a face image sequence will be described with reference to FIG. 10A. A device 1001 is an example of the authentication apparatus 30 and includes an imaging apparatus 1002 and a touch display 1003 (serving as the input device 34 and the output device 35). After a person to be authenticated ends the registration of a product desired to be purchased, a message for prompting the person to be authenticated to select a payment method is displayed on the touch display 1003. The image capturing unit 301 starts to capture an image by being triggered by a tap of the person to be authenticated on a button 1004 for making payment using face authentication. In image capturing, the device 1001 may display a guide 1011 into which a face is to be fitted as illustrated in FIG. 10B and issue an instruction to the person to be authenticated in such a manner that a face appears in a size suitable for face authentication and account recognition.

The image transmission unit 302 transmits the face image sequence captured by the image capturing unit 301 to the image acquisition unit 101 of the management apparatus 10.

The processing in steps S702 and S703 is similar to that in FIG. 7. In step S703, if a matching score of the person A is larger than or equal to the second threshold value, the face authentication unit 103 determines that the person to be authenticated is identified as the person A (YES in step S703), the face authentication unit 103 advances the processing to step S902.

In step S902, the determination unit 105 refers to the membership information (account table in FIG. 6B) stored in the storage unit 107, and counts the number of accounts associated with the person A. If the number of accounts associated with the person A is zero (“ZERO” in step S902), the determination unit 105 advances the processing to step S706. In step S706, the determination unit 105 determines that account selection has failed. In this case, the management apparatus 10 uses the touch display 1003 to prompt the person to be authenticated to make payment using a method other than face authentication. The management apparatus 10 may also display a message indicating that no account exists on the touch display 1003.

If the number of accounts associated with the person A is one or more (“ONE OR MORE” in step S902), the determination unit 105 advances the processing to step S707. After step S707, the processing proceeds to step S903.

In step S903, the determination unit 105 compares the face input recognized in step S707 with the membership information (account table in FIG. 6B) stored in the storage unit 107, and identifies an account selected by the person to be authenticated.

If account identification has succeeded, the determination unit 105 determines that this account has been selected and advances the processing to step S905. At this time, the management apparatus 10 may display information regarding the identified account on the touch display 1003, and if the information includes an error, the management apparatus 10 may cause the person to be authenticated to correct the error. The correction may be performed by the person to be authenticated touching the touch display 1003, or the person to be authenticated executing a specific face input, such as head shaking, toward the imaging apparatus 1002.

If account identification has failed, the determination unit 105 advances the processing to step S904. In step S904, the management apparatus 10 stops the authentication processing. In other words, in a case where a payment method corresponding to the face input recognized in step S707 does not exist in the account table in FIG. 6B, the management apparatus 10 does not select a payment method. The management apparatus 10 may notify the person to be authenticated that account identification has failed, using the touch display 1003.

In the present exemplary embodiment, a person to be authenticated is to perform a face input of some sort to perform authentication processing.

The face input has two effects e.g., more secure personal authentication and prevention of unintended authentication processing that are to be obtained.

First, the effect of more secure personal authentication will be described. In the present exemplary embodiment, a face input registered by a person to be authenticated during the registration processing is handled as information (confidential information) known only by the person to be authenticated. For this reason, a face input performed by a person to be authenticated during the authentication processing also functions as knowledge-based authentication, and thus protection from a presentation attack by a malicious third party can be improved. Here, there is a risk that the face input serving as confidential information leaks by publicly performing a face input. Nevertheless, the leakage risk of the face input can be reduced by using a method of increasing the complexity of face input (e.g., a plurality of types of consecutively performed actions are regarded as one face input), or a method of making only a face input less visible from a person in the background usable.

Next, the effect of the prevention of unintended authentication processing will be described. The face input in authentication processing is voluntarily performed by a person to be authenticated. This can thus prevent processing of some sort (e.g., payment) from being performed by a person to be authenticated accidentally looking into a payment terminal placed in a public space, for example.

In step S905, the spoofing determination unit 108 calculates a non-living material score, which is a score indicating a likelihood of a non-living material, based on a face image sequence acquired by the image acquisition unit 101. For the spoofing determination, an arbitrary known technique can be applied.

As an example, a case of learning a spoofing determination device that calculates a non-living material score based on an image sequence will be described. First, a set of image sequences in which a living individual appears and a set of image sequences in which a non-living material appears are collected as training data. Then, a binary classification neural network is trained using these pieces of training data. The binary classification neural network classifies an input image sequence into class 0 in a case where a living individual appears in the input image sequence, and classifies an input image sequence into class 1 in a case where a non-living material appears in the input image sequence. By using a sigmoid function as an activating function of an output layer of this neural network, an output from the neural network becomes a scalar ranging from 0 to 1. This output value is used as a non-living material score.

If an input image sequence of spoofing determination includes a face input, such as head shaking, the accuracy of spoofing determination generally improves. This is attributed to the fact that a real face is three-dimensional while paper on which a face image is printed is planar. For this reason, a variation in a distance between part points differs between the case of changing the orientation of paper on which a face image is printed, and the case of changing a face orientation of a real face, and spoofing determination becomes easier. That is, a part of face inputs contributes to accuracy improvement of spoofing determination, and the reliability of personal authentication improves.

The spoofing determination unit 108 transmits the calculated non-living material score to the determination unit 105.

In step S906, the determination unit 105 determines whether the person to be authenticated is a living individual, based on the non-living material score. If the non-living material score calculated in step S905 exceeds a third threshold value, the determination unit 105 determines that the person to be authenticated is not a living individual (NO in step S906), determines that the person to be authenticated is highly likely to be spoofing, and advances the processing to step S907. In step S907, the management apparatus 10 stops the authentication processing, and does not select a payment method. At this time, to avoid providing information to a malicious attacker, it is desirable not to display the reason for authentication processing termination.

In a case where the non-living material score is smaller than or equal to the third threshold value, the determination unit 105 determines that the person to be authenticated is a living individual (YES in step S906) and advances the processing to step S908.

In step S908, the management apparatus 10 executes payment processing. In the payment processing, the management apparatus 10 selects and uses a payment method associated with the account selected in step S903 to pay an amount corresponding to a product selected by the person to be authenticated.

Heretofore, a flow of the authentication processing to be executed by the authentication apparatus 30 according to the second exemplary embodiment has been described. Nevertheless, the method of the authentication processing is not limited to the above-described method, and various modifications can be made.

For example, the method of performing one-to-N face authentication, face input recognition, and spoofing determination in order has been described with reference to the flowchart in FIG. 9. The order of the processing needs not be fixed. For example, modification can be made in such a manner that one-to-N face authentication, face input recognition, and spoofing determination are concurrently executed. This modification can further shorten a time taken for authentication processing.

The addition processing of spoofing determination is not always required and can be omitted in accordance with a security level required by the system or an allowable calculation amount.

As described above, the authentication system 1 according to the second exemplary embodiment enables a person to be authenticated to select a payment method simultaneously with the person identification of the person to be authenticated when the person to be authenticated makes payment using face authentication at an electronic cash register in a supermarket or a convenience store. Furthermore, two effects of reliable personal authentication and prevention of unintended authentication processing are obtained by using both spoofing determination that uses a face image sequence and knowledge-based authentication that uses a face input.

In a third exemplary embodiment, an effect of distinguishing between similar persons to be authenticated that can be added to face input will be described. In the third exemplary embodiment, the description of parts similar to those in the second exemplary embodiment will be omitted, and only differences will be described.

An authentication system 1 according to the third exemplary embodiment performs registration processing and authentication processing.

### [Registration Processing]

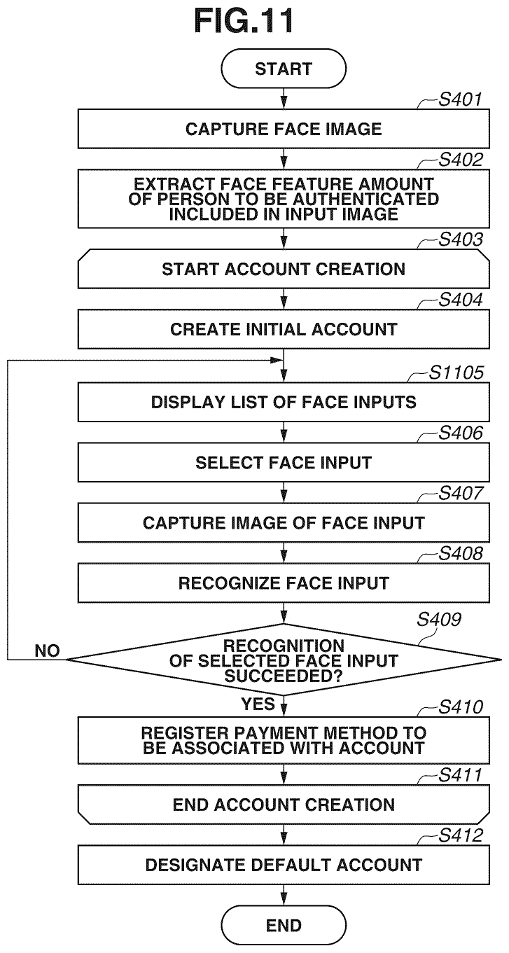

FIG. 11 is a flowchart illustrating a flow of the registration processing to be executed by the authentication system 1 according to the third exemplary embodiment. An example of a flow of the registration processing to be executed by the management apparatus 10 and the registration apparatus 20 according to the present exemplary embodiment will be described with reference to FIG. 11. In FIG. 11, the processing equivalent to the processing described with reference to FIG. 4 is assigned the same step number. Hereinafter, points where FIG. 11 differs from FIG. 4 will be described.

Hereinafter, a case will be considered where persons α and β with faces similar to each other exist, a similarity degree between face feature amounts extracted from their face photos is very high, and the persons α and β cannot be distinguished only based on the face feature amounts. The person α has already completed the registration processing, the person α has created two accounts and set a face input a1 and a face input a2 for the respective accounts. Hereinafter, details of the registration processing to be performed by the person β from now will be described.

The processing in steps S401 to S404 is similar to the processing in FIG. 4. After step S404, the processing proceeds to step S1105.

In step S1105, the membership information management unit 106 presents a list of face inputs settable by the person to be authenticated to the person to be authenticated in the form of a list or the like through the output device 35 of the registration apparatus 20. FIG. 5C illustrates the example. For example, if the person to be authenticated selects the pulldown menu 503, options of face inputs selectable by the person to be authenticated are displayed as a list.

The creation of this face input list is performed in the following procedure. Here, it is assumed that the person β creates an initial account.

First, the membership information management unit 106 calculates a similarity degree between a face feature amount stored in the general account table in FIG. 6A and a face feature amount of the person to be authenticated (here, the person β) that has been extracted in step S402. The membership information management unit 106 then lists a person ID of a person with the calculated similarity degree that is larger than or equal to a fourth threshold value, as a high similarity degree person ID list. The high similarity degree person ID list also includes the person in question (here, the person β).

Next, the membership information management unit 106 searches the account table in FIG. 6B for records with a person ID included in the high similarity degree person ID list, and lists face inputs associated with these records, as a used face input list.

Next, the membership information management unit 106 sets face inputs obtained by excluding face inputs included in the used face input list, from face inputs recognizable by the authentication apparatus 30, as face inputs settable by the person to be authenticated.

For example, if only the person α exists as a person whose face feature amount is similar to that of the person β, a person ID of the person α and a person ID of the person β are listed as the high similarity degree person ID list. The face input a1 and the face input a2 are then listed as the used face input list. Lastly, if a set of face inputs recognizable by the authentication apparatus 30 is denoted by A, a set obtained by excluding the face input a1 and the face input a2 from the set A corresponds to face inputs settable by the person to be authenticated.

The membership information management unit 106 performs control in such a manner as to display options of face inputs excluding face inputs associated with an account table of different persons to be authenticated with a face feature amount whose similarity degree to the face feature amount extracted in step S402 is larger than or equal to the fourth threshold value, among a plurality of face inputs.

Nevertheless, if a face input list created using the above-described method is presented to the person β, the person β can recognize that a person similar to the person β has already used the face input a1 and the face input a2. In a case where the person β is a malicious user, the person β can pretend to be another person (here, the person α) by using the face input a1 and the face input a2 in the authentication processing to be described below. For this reason, the membership information management unit 106 may also simultaneously exclude a face input selected at random, in addition to face inputs included in the used face input list, from face inputs recognizable by the authentication apparatus 30. This can prevent the person β from pretending to be another person.

The subsequent processing in step S406 to S412 is similar to the processing in FIG. 4.

### [Authentication Processing]

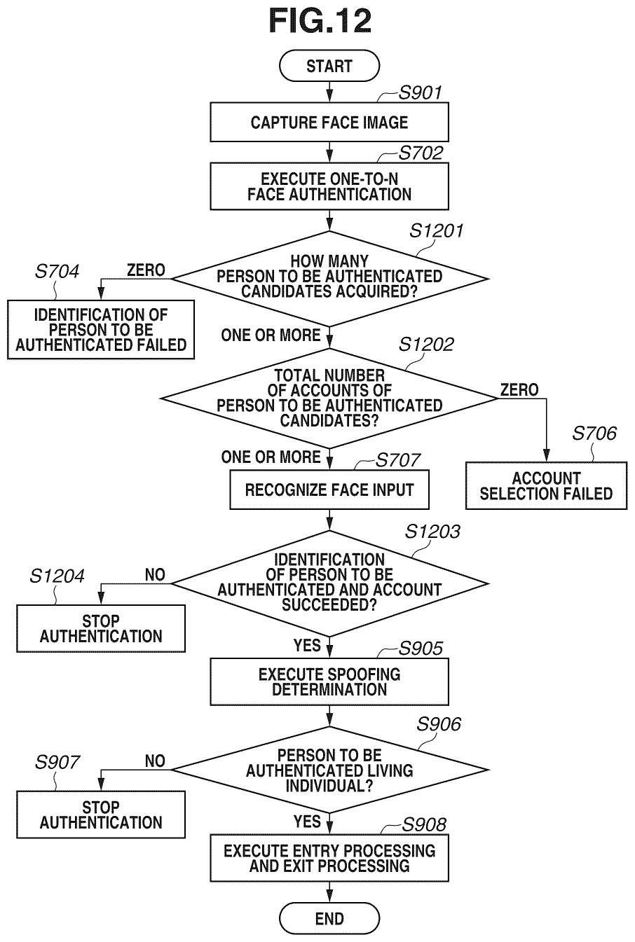

FIG. 12 is a flowchart illustrating a flow of the authentication processing to be executed by the authentication system 1 according to the third exemplary embodiment. An example of a flow of the authentication processing to be executed by the management apparatus 10 and the authentication apparatus 30 according to the present exemplary embodiment will be described with reference to FIG. 12. In FIG. 12, the processing equivalent to the processing described with reference to FIG. 9 is assigned the same step number. Hereinafter, points where FIG. 12 differs from FIG. 9 will be described.

The processing in steps S901 and S702 is similar to the processing in FIG. 9. After step S702, the processing proceeds to step S1201.

In step S1201, the face authentication unit 103 acquires all persons whose matching scores are larger than or equal to a fifth threshold value, among matching scores corresponding to the N persons that have been calculated in step S702, as a candidate list. The candidate list is interpreted as a list including persons who might be the same person as the person to be authenticated. In a case where the number of persons included in the candidate list is zero (“ZERO” in step S1201), it is determined that the person to be authenticated is a person different from all of the N persons, and the processing proceeds to step S704. In a case where the number of persons included in the candidate list is one or more (“ONE OR MORE” in step S1201), the processing proceeds to step S1202.

In step S704, the face authentication unit 103 determines that the identification of a person to be authenticated has failed.

In step S1202, the determination unit 105 refers to the membership information (account table in FIG. 6B) stored in the storage unit 107 and counts the total number of accounts associated with any person included in the candidate list. In a case where the counted total number is zero (“ZERO” in step S1202), the processing proceeds to step S706. In a case where the counted total number is one or more (“ONE OR MORE” in step S1202), the processing proceeds to step S707.

In step S706, the determination unit 105 determines that account selection has failed. The processing in step S707 is similar to the processing in FIG. 9. After step S707, the processing proceeds to step S1203.

In step S1203, the determination unit 105 compares the face input recognized in step S707 with the membership information (account table in FIG. 6B) stored in the storage unit 107, and simultaneously perform the identification of a person to be authenticated and the identification of an account selected by the person to be authenticated. This can be implemented by sequentially referring to records in the account table that are associated with any person existing in the candidate list, and searching for a record in which the same face input as the face input recognized in step S707 is registered.

In a case where the identification of a person to be authenticated and an account has succeeded, the determination unit 105 advances the processing to step S905. At this time, the management apparatus 10 may display information regarding the identified person to be authenticated and the account, on the touch display of the authentication apparatus 30, and if the information includes an error, the management apparatus 10 may cause the person to be authenticated to correct the error. The correction may be performed by the person to be authenticated touching the touch display, or the person to be authenticated executing a specific face input, such as head shaking toward the imaging apparatus, for example.

In a case where the identification of either a person to be authenticated or an account has failed, the determination unit 105 advances the processing to step S1204. In step S1204, the management apparatus 10 stops the authentication processing. The management apparatus 10 may notify the person to be authenticated of the stop via the touch display on the authentication apparatus 30.

The processing in steps S905 to S908 is similar to the processing in FIG. 9.

As described above, the authentication system 1 according to the third exemplary embodiment can add an effect of distinguishing between similar persons to be authenticated, to face input.

In a fourth exemplary embodiment, the description will be given of the configuration in which, unlike the first to third exemplary embodiments, the person identification of a person to be authenticated that uses face authentication, and the selection of some sort by a person to be authenticated can be simultaneously performed at high speed even in a case where the person to be authenticated does not preliminarily register membership information corresponding to an account table.

Hereinafter, a case will be described, as an example, where a person to be authenticated simultaneously performs biometric authentication that uses face authentication and the selection of an in-flight meal, at the entrance of a boarding gate in an airport.

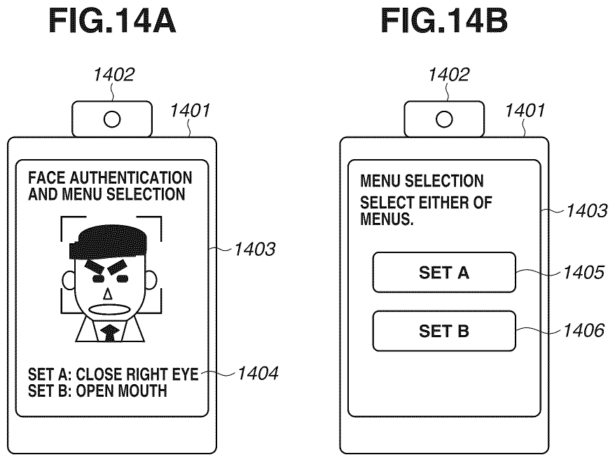

FIG. 14A is a diagram illustrating an example of a device 1401. The device 1401 is an example of the authentication apparatus 30. The authentication apparatus 30 is provided at the entrance of a boarding gate in an airport. The authentication apparatus 30 includes an imaging apparatus 1402 and a touch display 1403 (serving as the input device 34 and the output device 35). The correspondence between a face input and an item is clearly indicated in a text box 1404.

### [Registration Processing]

In the registration processing, only processing is performed corresponding to steps S401 and S402 from among the processing steps in the flowchart in FIG. 4 that have been described in the first exemplary embodiment. In other words, only membership information corresponding to the general account table in FIG. 6A is assumed to be stored in the storage unit 107.

### [Authentication Processing]

An example of a flow of the authentication processing to be executed by the management apparatus 10 and the authentication apparatus 30 according to the present exemplary embodiment will be described with reference to FIG. 7.

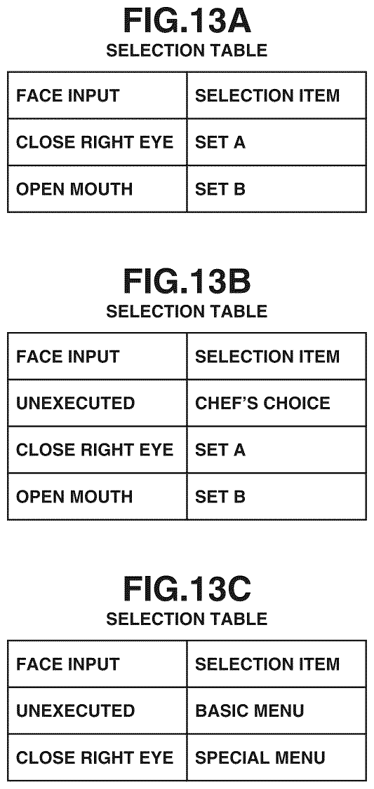

A selection table indicating association between a face input and a selection item is assumed to be prestored in the storage unit 107. FIG. 13A illustrates an example of the selection table. In this example, a face input of closing a right eye is associated with a set A of an in-flight meal, and a face input of opening a mouth is associated with a set B of an in-flight meal. Hereinafter, the selection item will be simply referred to as an item.

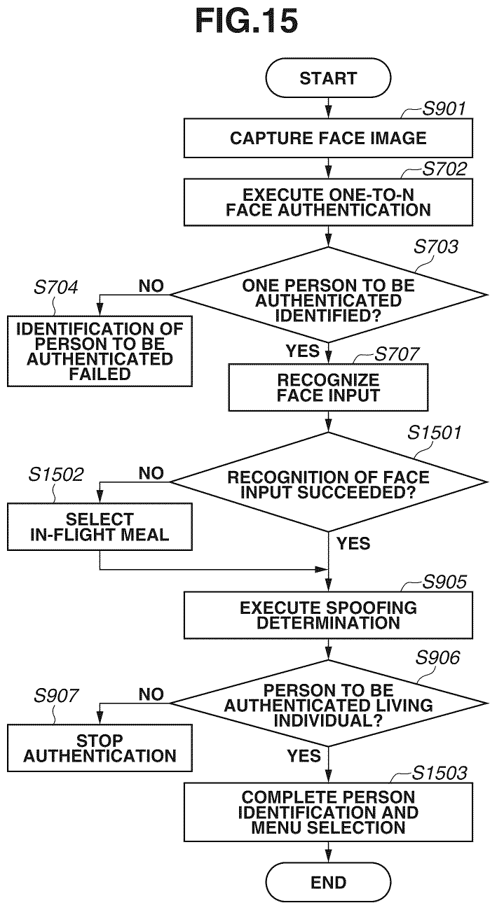

FIG. 15 is a flowchart illustrating a flow of the authentication processing to be executed by the authentication system 1 according to the fourth exemplary embodiment. An example of a flow of the authentication processing to be executed by the management apparatus 10 and the authentication apparatus 30 according to the present exemplary embodiment will be described with reference to FIG. 15. In FIG. 15, the processing equivalent to the processing described in FIG. 9 is assigned the same step number. Hereinafter, points where FIG. 15 differs from FIG. 9 will be described.

The processing in steps S901 and S702 to S704 is similar to the processing in FIG. 9. In step S703, in a case where the matching score of the person A is larger than or equal to the second threshold value, the face authentication unit 103 determines that the person to be authenticated is identified as the person A (YES in step S703), and advances the processing to step S707.

The processing in step S707 is similar to the processing in FIG. 9. After step S707, the processing proceeds to step S1501.

In step S1501, the determination unit 105 checks the face input recognized in step S707, against the selection table in FIG. 13A that is stored in the storage unit 107, and identifies an item selected by the person to be authenticated. This can be implemented by sequentially referring to records existing in the selection table, and searching for a record in which the same face input as the face input recognized in step S707 is registered. The selection table is a table of a plurality of associations of face inputs and selection items.

In a case where an applicable record does not exist, the determination unit 105 advances the processing to step S1502. At this time, the management apparatus 10 may clearly indicate that face input recognition has failed, on the touch display 1403.

In a case where an applicable record exists, the determination unit 105 selects a selection item associated with the record (i.e., in-flight meal selected by the person to be authenticated) and stores the selection item into the storage unit 107.

At this time, the management apparatus 10 may display information regarding the selected selection item on the touch display 1403. If the information includes an error, the management apparatus 10 may cause the person to be authenticated to correct the error. After that, the processing proceeds to step S905.

In step S1502, the determination unit 105 causes the person to be authenticated to select an in-flight meal. This can be implemented by arranging a button 1405 of the set A and a button 1406 of the set B that correspond to selection items of the device 1401, on the touch display 1403 as illustrated in FIG. 14B, for example. In a case where a selection item corresponding to the face input recognized in step S707 does not exist in the account table in FIG. 6B, the determination unit 105 selects a selection item in accordance with an operation performed by the person to be authenticated. The determination unit 105 stores the selected selection item in the storage unit 107. Thereafter, the processing proceeds to step S905.

The processing in steps S905 to S907 is similar to the processing in FIG. 9. In step S906, in a case where the non-living material score is smaller than or equal to the third threshold value, the determination unit 105 determines that the person to be authenticated is highly likely to be a living individual and advances the processing to step S1503.

In step S1503, the management apparatus 10 performs postprocessing, such as the opening of the boarding gate and the preparation of in-flight meals, based on information regarding the identified person ID and the selected selection item (i.e., in-flight meal selected by the person to be authenticated).

As described above, according to the authentication system 1 according to the fourth exemplary embodiment, face authentication and selection of some sort can be simultaneously performed at high speed. As described in the second exemplary embodiment, an effect is also obtained of improving the accuracy of spoofing determination by causing a person to be authenticated to perform face input.

The processing to be executed by the authentication system 1 is not limited to the above-described processing, and various modifications can be made.

For example, modification can be made in such a manner that the clear indication of correspondence between a face input and an item like the text box 1404 in FIG. 14A becomes unnecessary. This can be implemented by preliminarily notifying the person to be authenticated that a face input of “nodding a head” corresponds to “yes” and a face input of “shaking a head” corresponds to “no”.

For example, modification can be made in such a manner that a default item is selected in a case where a person to be authenticated does not execute face input. For example, a selection table as illustrated in FIG. 13B is stored in the storage unit 107. In a case where a person to be authenticated has not actively performed selection (the case can also include a case where a person to be authenticated has moved away from the authentication apparatus 30), an in-flight meal of “chef's choice”, which is a default selection item, can be selected. By using this modification, such an effect that selection made by the person to be authenticated can be omitted is obtained in a case where a person to be authenticated finds active selection a burden. It is also expected that a certain percentage of persons to be authenticated are expected to select “chef's choice”, and thus it becomes easier for a service provider to control the number of selected in-flight meals.

In this example, a default selection item is “chef's choice”, but modification can be further made in such a manner as to set an item (e.g., “set A”) that is likely to be selected by the person to be authenticated, as a default selection item based on the past selection results of persons to be authenticated, for example. By using this modification, the probability that the person to be authenticated does not execute face input increases, and such an effect that the convenience of the person to be authenticated improves is obtained.

Modification can also be made in such a manner that it is determined that an additional option is selected, only when a person to be authenticated executes face input. For example, a selection table as illustrated in FIG. 13C is stored in the storage unit 107. In a case where a person to be authenticated has not actively performed selection (the case can also include a case where a person to be authenticated has moved away from the authentication apparatus 30), an in-flight meal of a basic menu, which is a default selection item, can be selected. In a case where a person to be authenticated has performed a special face input (here, “close a right eye”), an in-flight meal of a special menu requiring extra cost can be selected. By using this modification, only a person to be authenticated requiring an additional option is required to perform face input, and thus an effect of preventing an additional option unintended by a person to be authenticated from being erroneously selected is obtained.

As described above, according to the authentication system 1 according to the fourth exemplary embodiment, the person identification of a person to be authenticated that uses face authentication, and the selection of some sort by a person to be authenticated can be simultaneously performed at high speed even in a case where the person to be authenticated does not preliminarily register membership information corresponding to an account table.

Heretofore, the above-described exemplary embodiments have been described in detail, but the present disclosure is not limited to a specific exemplary embodiment, and various modifications or changes can be made within the gist described in the appended claims. The above-described exemplary embodiments each merely indicate a specific example, and the technical scope is not limited in a limited manner based on these. That is, the present disclosure can be executed in various forms without departing from the technical ideas thereof or the major features thereof.

According to the present disclosure, it is possible to efficiently perform the identification of a person indicating a person to be authenticated, and the selection of a selection item.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-132060, filed Aug. 14, 2023, which is hereby incorporated by reference herein in its entirety.

What is claimed is:

1. An information processing apparatus comprising:
one or more memories storing instructions; and
one or more processors that, upon execution of the stored instructions, are configured to:
identify a person based on a face feature amount extracted from one or more face images including a face of the person;
recognize, based on the face feature amount, a specific state of the face as a face input performed by the identified person from the one or more face images including the face of the identified person; and
execute processing of selecting one of a plurality of selection items based on the recognized face input.

2. The information processing apparatus according to claim 1, wherein the face input is at least one of a state of a face part, a state of a face orientation, a state of a face expression, a state of an eye direction, a state of a body part other than a face, a state of a specific object, a state of an accessory, a variation of a face part, a variation of a face orientation, a variation of a face expression, a variation of an eye direction, a variation of a body part other than a face, a variation of a specific object, or a variation of an accessory.

3. The information processing apparatus according to claim 1, wherein a selection item corresponding to the recognized face input is selected by referring to a table associating a face input and a selection item of the person to be identified.

4. The information processing apparatus according to claim 3, wherein execution of the stored instructions further configures the one or more processors to register a table of a plurality of associations of a face input and a selection item for each person.

5. The information processing apparatus according to claim 4, wherein execution of the stored instructions further configures the one or more processors to perform display control to display options of face inputs and to register a table associating a face input selected from the options of the face inputs and a selection item.

6. The information processing apparatus according to claim 5, wherein execution of the stored instructions further configures the one or more processors to perform control to selectively display options of face inputs, among a plurality of face inputs, that are easily discriminated from each other by a machine.

7. The information processing apparatus according to claim 1, wherein execution of the stored instructions further configures the one or more processors to extract a face feature amount based on a face image quality score indicating, as a number, a degree to which the face image is suitable for face authentication.

8. The information processing apparatus according to claim 3, wherein execution of the stored instructions further configures the one or more processors to select a default selection item when a selection item corresponding to the recognized face input does not exist in the table.

9. The information processing apparatus according to claim 3, wherein execution of the stored instructions further configures the one or more processors to display a message indicating that a selection item does not exist when the selection item corresponding to the recognized face input does not exist in the table.

10. The information processing apparatus according to claim 3, wherein execution of the stored instructions further configures the one or more processors to select a selection item in accordance with an operation performed by the identified person when a selection item corresponding to the recognized face input does not exist in the table.

11. The information processing apparatus according to claim 1,
wherein execution of the stored instructions further configures the one or more processors to
determine whether the identified person is a living individual, based on the one or more face images including the face of the identified person, and
select one of the plurality of selection items when the identified person is determined to be a living individual.

12. The information processing apparatus according to claim 11, wherein execution of the stored instructions further configures the one or more processors to not select a selection item when the identified person is determined not to be a living individual, the one or more processors stop processing of the selection.

13. The information processing apparatus according to claim 5, wherein execution of the stored instructions further configures the one or more processors to register a face feature amount extracted from the one or more face images including the face of the person to be authenticated.

14. The information processing apparatus according to claim 13, wherein execution of the stored instructions further configures the one or more processors to perform display control to display options of face inputs, among a plurality of face inputs, excluding face inputs associated with a table of a different person to be authenticated with a face feature amount whose similarity degree to the extracted face feature amount is larger than or equal to a threshold value.

15. The information processing apparatus according to claim 1, wherein the one of the plurality of selection items is a payment method, presence or absence of administrative right, an account type, a service type, or preference of a person to be authenticated.

16. The information processing apparatus according to claim 1, wherein execution of the stored instructions further configures the one or more processors to select a selection item corresponding to the recognized face input based on a table associating a face input and a selection item.

17. An information processing method to be executed by an information processing apparatus, the information processing method comprising:
identifying a person based on a face feature amount extracted from one or more face images including a face of the person;
recognizing, based on the face feature amount, a specific state of the face as a face input performed by the identified person from the one or more face images including the face of the identified person; and
executing processing of selecting one of a plurality of selection items based on the recognized face input.

18. A non-transitory computer-readable storage medium that stores a program that, when executed by one or more processors of a computer, causes the computer to:
identify a person based on a face feature amount extracted from one or more face images including a face of the person;
recognize, based on the face feature amount, a specific state of the face as a face input performed by the identified person from the one or more face images including the face of the identified person; and
execute processing of selecting one of a plurality of selection items based on the recognized face input.
